(19) United States
(12) Patent Application Publication
(10) Pub. No.: US 2026/0121417 A1
(43) Pub. Date: Apr. 30, 2026

(54) DYNAMIC LOSS COMPENSATION FOR POWER CONTROL APPARATUS

(71) Applicant: Inventus Holdings, LLC, Juno Beach, FL (US)

(72) Inventors: Michael A. Scott, Palm Beach Gardens, FL (US); Lester L. Weaver IV, North Palm Beach, FL (US)

(21) Appl. No.: 18/928,269

(22) Filed: Oct. 28, 2024

(51) Int. Cl. H02J 3/46; H02J 3/38; H02J 13/00

(52) U.S. Cl. CPC H02J 3/46; H02J 3/381; H02J 13/12; H02J 2103/35

(57) ABSTRACT

Systems and methods for controlling a multiple generating resource site. A controller receives from a check meter measured characteristics of power flowing through a power interconnect point. The controller receives measured power characteristics for each generating resource exchanging power through the power interconnect point. Based on the characteristics of power flowing through the power interconnect point and measured power characteristics for each generating resource, the controller determines: loss values for each transmission link system connecting each power generating resource to the check meter, and an apportionment of losses among those transmission link systems. Based on control data defining characteristics of power to be exchanged through the power interconnect point, power adjustments for the generating resources are determined based on the apportionment of losses. One or more of the generating resources are commanded to produce power based on the power adjustments.

### FIELD OF THE DISCLOSURE

The present disclosure generally relates to controlling electrical power generation systems, and more particularly to controlling electrical power generation output of multiple electrical power generating resources in a distributed generation system.

### BACKGROUND

Some electrical power sites include multiple electrical power generation resources that are sub-divided into groups and that are distributed over a large area. The electrical power generation resources in some examples include equipment that produce electrical power and also include systems that are sometimes able to consume some amount of electrical power. In some examples, electrical power generation resources can be separated into groups where all of the electrical power generation equipment in each group exchanges electrical power through a respective group electrical meter. In some examples, a respective electrical power transmission link system connects each of these group electrical meters to an interconnect electrical meter at a power interconnection point. Electrical power is exchanged through this power interconnection point with a user or provider of power such as an electrical grid. In some examples, such as a large electrical power site incorporating renewable energy generation equipment, the different groups can be dispersed over a large geographic area. For example, a particular group may consist of a large, utility level photovoltaic cell generation site, a large windfarm, a Battery Energy Storage System (BESS), other types of electrical power equipment, or combinations of these.

The operation of such a large electrical power site with multiple groups often involves the site receiving a specification of the total electrical power that the entire site is to be exchanged through the power interconnection point. Such a specification is able to specify various characteristics, such as quantities specifying real power, reactive power, other quantities, or combinations of these, of the electrical power exchanged through the power interconnection point. Operations of such a large electrical power site includes controlling the electrical power generation or demand characteristics of each of these groups in order to maintain the specified quantities for the electrical power that is exchanged through the common interconnect point. In various examples, controllers for the large electrical power site operate to maintain these specified quantities as the electrical power output of the different groups varies, such as variations in electrical power output produced by solar farms or wind turbine farms. Such electrical power output variations in some examples occur fairly rapidly and can at sometimes exceed the ability of monitoring and control equipment to make adjustments to the electrical power produced by different pieces of electrical power equipment.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 illustrates an electrical power site schematic, according to an example;

FIG. 2 illustrates transmission link systems for the electrical power site schematic of FIG. 1, according to an example;

FIG. 3 illustrates a generating resource adjustment process, according to an example; and

FIG. 4 illustrates a block diagram illustrating a computing system, according to an example.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the disclosed subject matter in virtually any appropriately detailed structure and function. Further, the terms and phrases used herein are not intended to be limiting, but rather, to provide an understandable description.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The below described systems and methods in an example provide an improved power controller for renewable sites with multiple power generation assets. The below described systems and methods address conventional approaches that use multiple revenue meters for transformer and line-loss power compensation. The associated time delays introduced between measurements made by these meters in conventional systems may result in system oscillations, suboptimal power output, other issues, or combinations of these. The below described systems and methods include a low-lag-time power control system that addresses the issues present in conventional systems and support sites with multiple electrical power generation resources to deliver appropriate electrical power levels to a common point of interconnection.

The below described systems and methods operate to determine losses introduced by each transmission link system that electrically connects multiple electrical power generating resources to a single interconnection point. In some examples, some of these multiple electrical power generating resources are able to be located at various distances, and sometimes at large distances, from one another and from the single interconnection point. These multiple electrical power generating resources and the transmission link systems that connect them to the single interconnection point are referred to herein as one electrical power site. In some examples, these electrical power generating resources are arranged as groups of electrical power equipment where each group of electrical power equipment exchanges electrical power through a group electric meter that in turn is connected to the single interconnection point by its own transmission link system. The single interconnection point, which is an example of a power interconnection point, connects to another portion of a part of an electric power infrastructure or to an electrical power consumer, such as a connection to an electrical grid.

Each electrical power generating resource, also referred to as a generating resource herein, is able to produce electrical power. In some examples, one or more electrical power generating resources are also able to receive electrical power. An example of an electrical power generating resource that is able to receive electrical power is a Battery Energy Storage System (BESS), or any other energy storage system, that receives electrical power over some time durations in order to store that electrical power and later provide the stored electrical power at other times.

In general, the operator of a system exchanging power through a power interconnection point to which an electrical power site is connected is able to provide specifications for the electrical power to be exchanged or conveyed through that power interconnection point. Such a specification is able to set forth various quantities such as, without limitation, real power, reactive power, power factor, other quantities, or combinations of these. In some examples, these specifications are able to specify fixed values, ranges, limits, other specifications, or combinations of these for these quantities. The specifications of these quantities are able to be specified as positive or negative values where negative values in an example reflect electrical power flowing from the electric power infrastructure into the one or more electrical power generating resources.

In some examples, such as where one or more of the electrical power generating resources include renewable energy sources, the electrical power output or demand of one or more of the connected electrical power generating resources of the electrical power site may fluctuate. The operation of the electrical power site is able to adjust the electrical power output or demand of other electrical power generating resources of the electrical power site to compensate for the change in output or demand of one of the electrical power generating resources.

In some examples, a controller of an electrical power site is able to monitor, either continuously or at various intervals, the electrical output or demand of each electrical power generating resource and the amount of electrical power exchanged through the power interconnection point. As variations are observed by the controller, the controller is able to adjust operating parameters of one or more electrical power generating resources to compensate for the observed variation. In various examples, the controller is able to operate to maintain the electrical power level exchanged through the power interconnection point to comply with specifications for that electrical power exchange. The rate of such variations in some examples exceeds the speed with which monitoring and control equipment can efficiently react to the variations. The inability of the monitoring and control equipment to respond to such variations with adequate speed in some examples can lead to power oscillations and sub-optimal power output levels from the generators.

The effect of an adjustment to the electrical output or demand of an electric power generating resource on the actual power exchanged through the power interconnection point is affected by the variability of losses introduced by a transmission link system based on the amount of electrical current carried by that system. In general, the loss incurred by an electrical transmission system is proportional to the square of electrical current carried by the system. Further, various phenomena within transformers can introduce additional losses.

In conventional control systems for electrical power site with multiple electrical power generation resources, a controller in some examples simply adjusts the output or demand of one or more electrical power generation resource by the same amount as a detected change in output or demand of one electrical power is system, or as a change in the total power exchanged through the single interconnection point. Due to the above described variations such as non-linearities of the transmission link systems, merely adjusting the output or demand of one electrical power generating resource by the same value of a change that was detected in another system may not result in maintaining a constant exchange of electrical power through the common interconnect point. In some examples, conventional power measurement systems operate to estimate the losses of transmission link systems to support more accurate adjustments to power output or demand of the electrical power generation resources. The operation of these systems introduces time delays between the measurements of various electrical power characteristics upon which estimates of losses are based and then performing the determined adjustments to power output or demand. These delays in adjusting electrical power generating resources after measuring their actual electrical power output can cause oscillations in the total output power of the electric power site and generally suboptimal power output of the electrical power generating resources and the entire electrical power site.

The below described systems and methods operate to obtain a more accurate and timely value of losses of the transmission link systems that connect each electrical power generating resource to the power interconnection point. As described below, the losses of the transmission link systems are monitored and evaluated so that a more timely loss value for each transmission link system is available at various times when adjustments are to be made to the output or demand of an electrical power generating resource to compensate for a change on another electrical power generating resource.

In an example, the below described systems and methods incorporate controllers that use communications architectures to more quickly receive relevant measured data values used to determine power transmission system losses and incorporate those losses into the power control of each electrical power generating resource. These controllers in an example contain interfaces that support more direct communications to support receipt of measured power characteristics for the electrical power outputs and demands of each electrical power generating resource and measurements of electrical power exchanged through a power interconnect point. Based on these received measurements, these controllers include processors that have processing power sufficient to rapidly perform calculations to determine more accurate values of losses introduced by the transmission link systems and adjust electrical power output. This architecture has been found to provide better response times for reacting to variations in the output or demand of one system, greatly reducing power oscillations in the electrical power delivered to the interconnection point caused by, for example, control system delays, and reducing operation of generators at sub-optimal power outputs.

Several advantages are provided by the relatively rapid time between measurements of electrical power characteristics, the determination of the losses introduced by each of the transmission link systems that connect the electrical power generating resources to the common interconnect point, and the application of operating adjustments to those systems. In a scenario where there is a specification of quantities for the total amount of electrical power exchanged through the power interconnection point, using a more timely determination of losses and the apportionment of those losses between the individual electrical power generating resources and the power interconnection point allows, for example, for a more efficient or equitable allocation of that total amount of electrical power between or among the different electrical power generating resources while minimizing possible oscillations that can be caused by time delays in the measurement to the output of the control process. In some examples, a more timely estimation of these losses allows more accurate adjustments of power characteristics for the electrical power generating resource to achieve, for example, specified characteristics for the electrical power exchanged through the single interconnection point. Increasing the timeliness of these adjustments improves their accuracy and reduces, for example, variations in electrical power characteristics during iterative adjustments that may be used to achieve various goals. Monitoring and control systems that are able to perform such processing in a more rapid manner have been found to improve the operation of various power generation installations, particularly installations that include generators that exhibit relatively rapid time variations in their electrical output production.

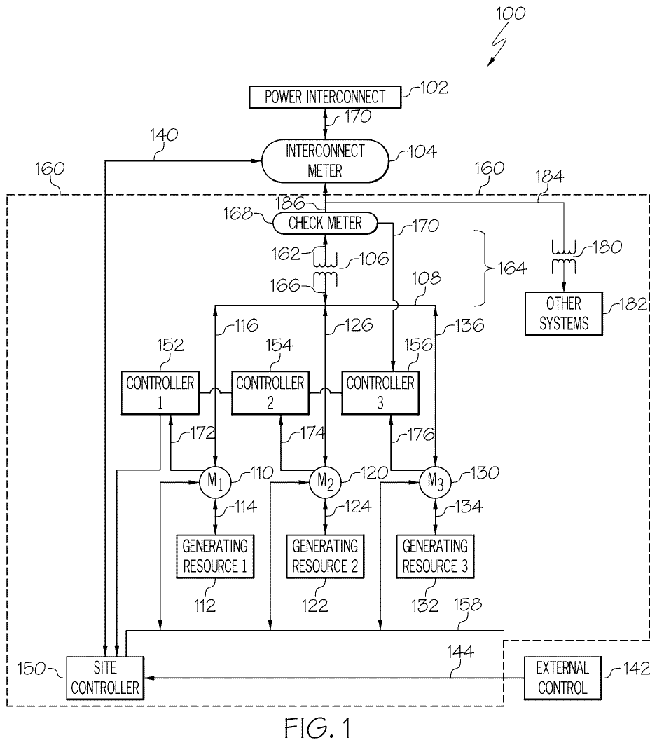

FIG. 1 illustrates an electrical power site schematic 100, according to an example. The electrical power site schematic 100 depicts components at an example electrical power site 160 along with a power interconnect 102 through which the electrical power site 160 exchanges electrical power. The electrical power site 160 is an example of a generating resource site that contains a number of generating resources that are able to generate electrical power and deliver that power to a power interconnect 102. In some examples, one or more of the generating resources are able to either produce or consume electrical power. In an example, one or more generating resources are able to include an energy storage system, such as a Battery Energy Storage System (BESS), that receives electrical energy as an electrical power demand and then acts as an electrical power source by providing the stored electrical energy as an output.

The power interconnect 102 in some examples is able to provide a connection between the electrical power site 160 and another potentially remote power generating resource that is able to do one or more of receive electrical power from the electrical power site 160, provide electrical power to the electrical power site 160, or combinations of these. In various examples, the power interconnect 102 is able to provide an electrical connection that is able to exchange electrical power with various systems such as, without limitation, electrical infrastructure elements including an electrical grid, other electrical systems, or combinations of these.

As is described in further detail below, the electrical power site 160 contains a number of generating resources that each has a respective group electrical meter and a respective transmission link system that connects each generating resource to a check meter 168. In an example, the multiple generating resources are all controlled by a common entity that monitors the electrical power consumed or produced by each generating resource and adjusts the electrical power output or consumption of each generating resource to achieve various goals. In an example, an entity associated with the power interconnect 102 specifies characteristics of electrical power to be exchanged through the power interconnect point. In an example, the entity specifies characteristics including total power delivered to the interconnection point, specifications of reactive power, other characteristics, or combinations of these. In an example, the below systems operate to adjust the operating parameters of each generating resource to maintain the specified characteristics of electrical power being exchanged through the power interconnect.

The power interconnect 102 in an example has an interconnect meter 104 that measures the characteristics of electrical power exchanged through the power interconnect 102. Measurements by the interconnect meter 104 are able to be used for various purposes such as for billing of electrical power exchanged through the power interconnect 102, verification of compliance with the specified characteristics of that electrical power, other purposes, or combinations of these. In an example, the operator(s) of equipment within the electrical power site 160 do not have ready and timely access to the measurements made by the interconnect meter 104. In order to improve the operations of the electrical power site 160, a check meter 168 is included as part of the electrical power site 160, such as at a physical boundary or other location, to measure the total electrical power exchanged with the electrical power site 160. The check meter 168 in an example is connected to the interconnect meter 104 via an interconnect link 186.

In some examples, a power interconnect 102 is able to provide connections to multiple electrical power systems. The depicted electrical power site schematic 100 shows a second interconnect transformer 180 that connects other systems 182 to a second interconnect line 184. In various examples, other systems 182 are able to include one or more of electrical power generation systems, electrical consumption systems, other electrical systems, or combinations of these. The second interconnect line 184 in the illustrated examples connects to the interconnect link 186 to exchange electrical power generated, consumed, or both by the other systems 182 through the power interconnect 102 and in some examples with the electrical power site 160.

The illustrated electrical power site 160 includes three (3) generating resources, generating resource 1 112, generating resource 2 122, and generating resource 3 132. In general, an electrical power site 160 is able to include any number of generating resources. In some examples, one or more electrical power generating resources are able to consume or produce electrical power. In one such example, a generating resource may include a Battery Energy Storage System (BESS) that operates alone or in conjunction with electrical power generation components. In some example, different generating resources are able to have different types of components, such as wind turbines, Photovoltaic (PV) cells, BESS components, fossil fuel powered generators, any type of electrical system that is capable of electrical power generation, consumption, or both generation and consumption, as well as any other types of components, or combinations of these.

Each generating resource in the illustrated example is an example of a group of electrical power equipment that is connected to exchange electrical energy through a respective group electrical power meter. Generating resource 1 112 is connected to a first group electrical power meter M1 110 by a first resource link 114, generating resource 2 122 is connected to a second group electrical power meter M2 120 by a second resource link 124, and generating resource 3 132 is connected to a third group electrical power meter M3 130 by a third resource link 134. Although these resource links are depicted as a single line, it is to be understood that any interconnection architecture is able to be used to connect electrical power generation equipment to a group electrical power meter.

Each generating resource has a transmission link system that electrically connects its group electrical power meter to the check meter 168. Details of the losses introduced by these transmission link systems are described in further detail below. All of the transmission link systems in the illustrated example convey electrical power through a common link portion 164 that includes a busbar 108, a busbar to transformer link 166, a transformer 106, and a transformer to check meter link 162. The common link portion 164 carries the electrical current either produced by or consumed by all of the generating resources in this example.

Each of the transmission link systems for each generating resource has a respective meter to busbar link to conduct power between the group meter and the busbar 108. The first group electrical power meter M1 110 has a first meter to busbar link 116, the second group electrical meter M2 120 has a second meter to busbar link 126, and the third group electrical power meter M3 130 has a third meter to busbar link 136.

The electrical power site schematic 100 has a site controller 150 that operates to at least partially control the generating resources and that also at least partially monitors electrical power quantities measured by each group electrical power meter and the check meter 168. In an example, each generating resource also has a respective local controller that is connected to the group electrical meter for that generating resource. A controller 1 152 in an example is connected directly to the first group electrical power meter M1 110 via a first group meter data link 172, a controller 2 154 in an example is connected directly to the second group electrical power meter M2 120 via a second group meter data link 174, and a controller 3 156 in an example is connected directly to the third group electrical power meter M3 130 via a third group meter data link 176. All of these local controllers in an example are configured to communicate data with one another and with the site controller 150 to support the below described operations.

The example architecture illustrated by the electrical power site schematic 100 depicts a site controller 150 that is separate from the local controllers, i.e., from controller 1 152, controller 2 154, and controller 3 156 in this example. In further examples, the functions described below as being performed by site controller 150 are able to alternatively be fully or partially incorporated into one or more of the local controllers, controller 1 152, controller 2 154, controller 3 156, or combinations of them. In such examples, those one or more local controllers that perform the functions of the site controller 150 that are described below then have site level responsibility. Such local controllers are able to be called a master controller and the other local controllers are then called slave controllers where the slave controllers then receive site specific commands from the master controller. Unless described otherwise, the term “controller” is used in the present discussion to refer to any of one or more site controllers, one or more local controllers, or combinations thereof.

As described in further detail below, the site controller 150, one or more of the local controllers, or a combination of these determines losses between each group electrical power meter and the check meter 168. These determined losses are used to more accurately adjust power input or output levels of the different generating resources in order to achieve particular objectives such as maintaining specified quantities for characteristics of the electrical power exchanged through the power interconnect 102.

In the illustrated example, one of the local controllers, controller 3 156 in this example, is configured to exchange data with the check meter 168 via a check meter data link 170. Controller 3 156 in an example communicates with controller 1 152, controller 2 154, and the site controller 150 to exchange the values received from the check meter 168, measurements made by other group meters, other data, or combination of these. In a further example, all of the controllers and meters, including the first group electrical power meter M1 110, the second group electrical power meter M2 120, and the third group electrical power meter M3 130, are connected to a shared communications resource, such as a common network, to allow any controller to exchange data with all of the meters. In some examples, the check meter data link 170 is a virtual link that is carried over any suitable communications architecture.

A generating resource data bus 158 supports exchanging data with group electrical meters including the first group electrical meter M1 110, the second group electrical meter M2 120, and the third group electrical meter M3 130. As described in further detail below, the site controller 150, one or more of the local controllers, or combinations of these, determines losses between each group electrical power meter and the check meter 168. These determined losses are used to more accurately adjust power input or output levels of the different generating resources in order to achieve particular objectives such as maintaining specified quantities for characteristics of the electrical power exchanged through the power interconnect 102.

The site controller 150 in an example has an interconnect meter data link 140 to exchange data with the interconnect meter 104. In an example, the site controller 150 receives measurements made by the interconnect meter 104 of various characteristics of the electrical power exchanged through the power interconnect 102. As noted above, the interconnect meter 104 is used for billing of electrical power exchanged through the power interconnect 102. The interconnect meter 104 in some examples provides measurements such as real power, reactive power, power factor, other quantities, or combination of these, to the site controller 150 to provide a better evaluation of the compliance of the electrical power exchanged through the power interconnect 102 with the requirements specified for that power, such as the characteristics defined by control data received from the external control 142.

The site controller 150 in an example further receives control data defining characteristics of the electrical power to be delivered to the power interconnect 102. In an example, the control data is received from an external control 142 via an external control data link 144. The external control 142 in an example is a controller associated with a system connected to the electrical power site 160. In general, the site controller 150 is able to receive specifications of the electrical power to be delivered to the power interconnect 102 from any source, in any format, or combinations of these. In various examples, the specifications of electrical power to be delivered to the power interconnect 102 are able to specify various quantities for that electrical power such as real power, reactive power, power factor, other quantities, or combination of these. In further examples, any one or more of the controllers including controller 1 152, controller 2 154, controller 3 156, or combinations of these, are able to receive this specification and perform the processing described below as performed by site controller 150.

Based on the received control data, the site controller 150 in an example determines an allocation of electrical power production or consumption that is allocated to each generating resource. Based on this determined allocation, the site controller 150 commands the various generating resources in the electrical power site 160 to produce electrical power in a manner that will result in electrical power to be delivered to the interconnect meter 104 with the characteristics specified in the received control data. In an example, such commands are provided to the respective local controller of each generating resource. The combination of the site controller 150 and the local controllers in an example further monitors variations in the electrical power produced by each generating resource and adjusts other generating resources to compensate for observed variations so as to maintain a consistent output at the check meter 168 that conforms to the specifications in the received control data. In an example, one of the local controllers, such as controller 3 156 in the illustrated example, determines and allocates losses in the transmission link systems between each generating resource and the check meter 168 so as to determine more accurate adjustments to make to other generating resources when a variation, such as a reduction, in the electrical power produced by one generating resource is detected.

In some examples, control data received from the external control 142 is able to specify new characteristics for the electrical power to be delivered to the power interconnect 102 that result in a change in the quantities characterizing the electrical power to be delivered to the power interconnect 102. Examples of such changes include, without limitation, increases or decreases in real power that is to be delivered to the power interconnect 102, increases or decreases in reactive power that is to be delivered to the power interconnect 102, other changes to the characteristics of the electrical power delivered to the power interconnect 102, or any combination of these. In an example, the site controller 150, one or more of the local controllers, or a combination of these, reacts to such changes by determining adjustments to be made to the output of one or more generating resource where the determination of that adjustment includes the losses introduced by the respective transmission link system for that one or more generating resource. By incorporating the losses introduced by the respective transmission link system for that one or more generating resource into the adjustment of that generating resource, the resulting characteristics of the electric power actually delivered to the interconnect meter 104, and thus delivered to the power interconnect 102, better align with the specified characteristics. This operation results in a faster adjustment of the power output of the electrical power site 160 to the specified characteristics and in some examples reduces output power variations such as overshooting, undershooting, other variations, or combinations of these, as the control system for the electrical power site 160 adjusts the output power to match the specified characteristics.

In some examples, one processor, such as a processor in controller 3 154 of the illustrated example, receives indications of electrical power characteristics as measured by the group electrical meters and the check meter 168. That same processor in an example is used to perform the determinations of the losses of each transmission link system, apportion losses among transmission link systems, and to determine any required adjustments to the electrical power output for each generating resource. Combining these determinations into processing performed by one processor advantageously decreases time latency for making adjustments to the output power of each generating resource to accommodate, for example, variations in output power of one generating resource or changes specified by command data for the electrical power generation site. Such decreases in latency improves the overall quality of the electrical power produced by the electrical power site 160 during output power adjustments. In some examples, the processor performing these operations is also a control processor for one of the generating resources. In various examples, the site controller 150, the respective local controllers, or combinations of them, include circuits, computer readable program code, or combinations thereof, that form an example of a power output allocation processor. In some examples, the processing to determine the losses of each transmission link system and apportioning those losses to each transmission link is performed within twenty milliseconds (20 mS).

In an example, one controller, such as one of controller 1 152, controller 2 154, controller 3 156 or site controller 150, operates to read measurement data from all of the meters in quick succession. For example, controller 2 154 is able to execute a program that accesses each of meter M1 110, meter M2 120, meter M3 130, and check meter 168 to receive presently available measurement data for the electrical characteristics measured by that meter. In an example, the controller receives measurements from each of these meters that represent electrical conditions that are less than four hundred (400) mS old such that the received measurements are an indication of measured electrical power characteristics that reflect electrical characteristics produced by the respective electrical power generating resource less than four hundred milliseconds (400 mS) prior to receipt by the controllers. In some examples, the controller receives measurements from each of these meters that represent electrical conditions that are less than one hundred (100) mS old such that the received measurements are an indication of measured electrical power characteristics that reflect electrical characteristics produced by the respective electrical power generating resource less than one hundred milliseconds (100 mS) prior to receipt by the controllers.

In some examples, the amount of electrical power or other characteristics of electrical power that is measured by the check meter 168 is further adjusted for losses in the interconnect link 186 to account for losses in the power line link between the check meter 168 and the interconnect meter 104. In an example, the transmission line losses of the interconnect link 186 are calculated by multiplying a squared value of the total current passing through the check meter 168 by three (3) times the resistance of the interconnect link 186. This total loss is allocated to each generating resource based on the same proportion as is calculated for allocating transformer losses as is described below.

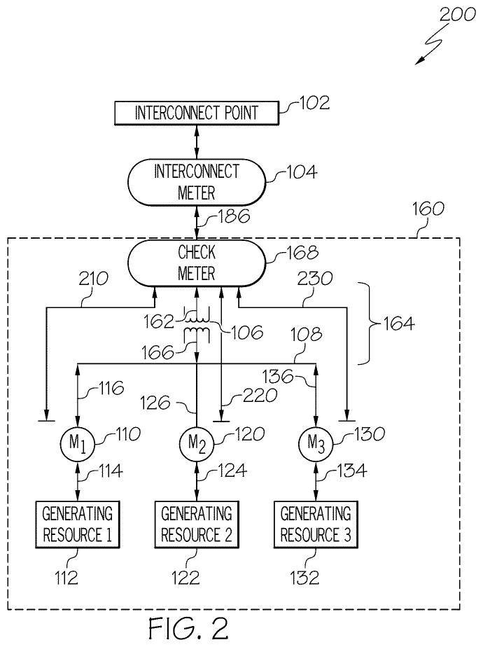

FIG. 2 illustrates transmission link systems 200 for the above described electrical power site schematic 100, according to an example. The transmission link systems 200 depicts the electrical connections that connect each group electrical power meter to the check meter 168. A first transmission link system 210 connect the first group electrical power meter M1 110 to the check meter 168, a second transmission link system 220 connects the second group electrical power meter M2 120 to the check meter 168, and a third transmission link system 230 connects the third group electrical power meter M3 130 to the check meter 168.

In the illustrated example, as discussed above, all of the illustrated transmission link systems include a common link portion 164 that includes the busbar 108, the busbar to transformer link 166, the transformer 106, and the transformer to check meter link 162. These components are shared by all of the transmission link systems and their losses are allocated to each generating resource according to the electrical current provided by that generating resource, as is described below. In addition to the common link portion 164, each of the transmission link systems for each generating resource has a respective meter to busbar link. The first group electrical power meter M1 110 has a first meter to busbar link 116, the second group electrical power meter M2 120 has a second meter to busbar link 126, and the third group electrical power meter M3 130 has a third meter to busbar link 136.

In order to more accurately determine the loss of each transmission link system while the electrical power generating resources of the electrical power site 160 are producing or consuming power, losses between the electrical power generating resources and the check meter 168 are determined and apportioned among the transmission link systems. Examples of calculations to perform these determinations are described below.

Determining losses through transmission link systems takes into account the phenomenon that when power flows through wires in a transformer and other electrical devices there is loss in the form of heat resulting from the flow of current through the resistance of the electrical path. These losses increase by the square of the current magnitude based upon the equation, where power lost=I²*R. These losses reduce the amount of electrical power delivered to the interconnect meter 104. In addition, even purely electrical power generating resources also consume power when not producing electrical power, such as the power consumed by heaters, lighting, pumps, and the like. This power is generally provided by other generating resources or through the power interconnect 102. This power is delivered through the power interconnect 102 to the generating resources over the same transmission link systems. In the case of power being consumed by generating resources, the power delivered to and measured by the interconnect meter 104 is the power produced by the generating resources reduced by the amount of electrical power consumed by the generating resources, either as a load or for energy storage, and the losses across the transmission link systems.

In some examples, the determination of the total electrical loss across the transmission link systems and the apportionment of that loss to each transmission link system, which can be used to calculate the reduction of electrical power generation of each generating resource to reflect the losses introduced by its respective transmission link system, accommodates scenarios where the direction of power flows may be different between the generating resources. Such a difference in power flow directions includes a scenario where one generating resource is producing electrical power while another is consuming electrical power to, for example, support operating equipment in the generating resource, charge BESS systems, support other activities, or combinations of these.

The site controller 150, one or more local controllers, or a combination of these, in various examples performs processing to determine losses introduced by the transmission link systems and to allocate the losses among each of the transmission link systems that connect the generating resources to the check meter 168. In an example, this processing uses measurements reported by the check meter 168 and each group power meter to determine loss ratios where a value of a particular loss ratio is a proportion of the amount of total system losses that is to be apportioned to an individual generating resource. In some examples, losses of the interconnect link 186 are determined based on determined values of resistance of the interconnect link 186 and the total electrical current flowing through the check meter 168, and the losses of the interconnect line are then allocated to each generating resource in order to adjust calculations of the electrical power delivered to the interconnect meter 104 by each generating resource. Such adjustments are used, for example, to allocate revenue or costs associated with electrical power exchanged through the interconnect meter 104, as is measured by the interconnect meter 104, to each generating resource.

### First Apportionment Example

In a first example, processing performed by site controller 150, one or more of the local controllers, or a combination of these, allocates determined losses between the group electrical meters and the check meter 168 based on the amount of electrical current measured by the group electrical meters. In one such example, the total amount of determined electrical power loss is allocated to each generating resource based on the ratio of electrical current produced by that generating resource divided by the total amount of electrical current produced by all of the generating resources providing electrical power to the check meter 168.

In this first example, the total amount of determined electrical power loss is the difference between the amount of electrical power measured by the check meter 168 and the sum of electrical power produced by each generating resource. In an example of N generating resources, the total amount of determined electrical power loss is given by the equation:

$${Loss}_{total} = {\sum }_{i - 1}^{N} {power}_{group meter i} - {power}_{check meter} \qquad ( 1 )$$

Where power_{group meter i} is the electrical power measured by group meter with index i, where i in the illustrated example is an integer between 1 and 3, and corresponds to the group meter measuring power exchanged with the particular generating resource having that same index. In the illustrated example, this corresponds to one of group electrical meter M1 110, group electrical meter M2 120, or group electrical meter M3 130, and power check meter is the electrical power measured by check meter 168. The total loss given by the above equation is apportioned to each generating resource i according to the following equation:

$${Loss}_{apportioned to i} = {Loss}_{total} * \frac{{I}_{group meter i}^{2}}{{\sum }_{j = 1}^{N} {I}_{group meter j}^{2}} \qquad ( 2 )$$

Where “I” represents the electrical current measured by a group electrical meter for the particular generating resource i or j.

This first apportionment example is an example of determining the apportionment of losses based on a loss ratio comprising a ratio of a square of electrical current flowing through a particular electrical power generating resource to a sum of all respective squares of electrical current flowing through each electrical power generating resource in a plurality of electrical power generating resources.

### Second Apportionment Example

In a second example, the processing performed by the site controller 150, one or more of the local controllers, or a combination of these determines several different losses that are introduced by components of the transmission link systems. In some cases, this second example incorporates design parameters of the different transformers and transmission links to more accurately support calculation of real and reactive losses in each of these systems. In an example, the losses in a transmission link system can be divided into no-load losses and load losses. No-load losses are losses that are incurred when no electrical current is flowing through the system to the power interconnect 102 but AC voltages are applied to the transformers, which generate magnetic currents in the iron of the transformer. Load losses are primarily resistive losses incurred by current flowing through the conductors of the transformer windings and transmission links.

In an example, parameters to calculate no-load losses and load losses of one or more transformers are determined based upon values obtained from, for example, a manufacturer's factory test report. In some examples, measured values are able to be determined for installed equipment and those values are able to be used in the calculations.

No-load losses occur any time the transformer and transmission link are energized. As such, each generating resource shares in these losses regardless of their generation output or load demand levels. The no-load losses are allocated in an example based upon a ratio of the rated operational, e.g., a maximum rating for, output or demand power level value of each generating resource to a total of the combined rated output or demand power level value the total of all generating resources. In an example, a no-load loss ratio is developed that is the proportion of the total no-load loss that is to be allotted to the separate generating resources. These no-load loss ratios in an example are fixed by the rated power capacity of the generating resource and do not change during operation of the electrical power site 160.

Load losses occur due to the flow of current through resistive conductors and as such translate directly to actual flow of electrical current either produced by or received by the generating resource. As such, load loss ratios between the different generating resources are determined based upon the apparent power being exchanged with each resource. In an example, the apparent power is specified as Kilo Volt-Amp (KVA), which is the product of the magnitude of kilovolts and current in amperes being exchanged with the generating resource. These loss ratios are able to be dynamic and will change instant by instant depending upon the flows at that instant. In an example, the no-load loss ratio and load loss ratio for a particular generating resource are independently calculated and applied in calculations for each generating resource to reduce the value of calculated electrical power delivered to the interconnect meter 104 by that generating resource.

Electrical power generated or consumed by each generating resource consists of both real and reactive power. Real and reactive power are not added together directly as they are 90 degrees apart in relationship and as such must be combined vectorially. When combined vectorially, real power KW and reactive power KVAR become apparent power KVA.

In an example, calculations to determine load loss ratios for each generating resource include an extra multiplying term to account for instances where some generating resources have power flows in the opposite direction as other generating resources. Using an example of two generating resources to illustrate such an instance where one generating resource is providing electrical power and the other is consuming electrical power, these two generating resources can be referred to as generating resource A and generating resource B. A multiplying term is used to account for this scenario where the multiplying term is the ratio of KVA_{A+B}/(KVA_{A}+KVA_{B}). In this equation, KVA_{A+B} is the combined value of apparent power produced by the connected combination of generating resource A and generating resource B. When one generating resource is providing power and the other generating resource is consuming power, this value is the difference between these absolute values. The values KVA_{A} and KVA_{B} are the positive values of the apparent power either produced or consumed by these respective generating resources. The load loss ratio to be applied to each generating resource in an example is further multiplied by the value of this ratio to determine the total proportion of load losses to be allocated to each generating resource. When the direction of power flow is different for two generating resources, the combined KVA_{A+B} term becomes smaller than the simple arithmetic sum of the individual KVA_{A}+KVA_{B} and results in load loss ratios that do not reflect the actual current flow. This factor corrects the load loss ratio for the cases where the flow reversals result in an improper ratio. When the flows are in the same direction, the factor is 1.0 and has no effect.

In one example, the transformer losses are determined and allocated to each generating resource. In an example, no-load losses are determined first followed by the determination of load loss. Once these values are determined, the total determined values of no-load losses and load losses are then allocated to each generating resource based on the loss ratios described above.

In an example, the process determines load losses that occur in the transmission link and then allocates them to each generating resource. The transmission link real power losses are all load based and in an example are allocated using the total loss factors to be applied to each generating resource. The reactive losses in a transmission link include series losses that again occur due to load flow and in an example are allocated again using the total load loss factors. The transmission link also acts like a generator due to shunt capacitance of the line. This capacitance occurs any time the line is energized and as such in an example is allocated based on the no-load loss factors described above.

This second apportionment example is an example of determining that the apportionment of losses is based on a combination of no-load losses and load losses, in which the no-load losses are allocated to each respective generating resource based on a ratio of the respective generating resource rated power capacity to the total rated power capacity of all generating resources within the plurality of generating resources, and the load losses are allocated to each respective generating resource based on a ratio of a product of voltage and amperage of each respective electrical power generating resource to a total of products of voltage and amperage of all electrical power generating resource.

In some conventional systems, the check meter 168 and group meters such as the first group electrical power meter M1 110, the second group electrical power meter M2 120, and the third group electrical power meter M3 130, are able to exchange data with one another. In various examples, these meters are able to communicate data with each other by any suitable technique. In some of these conventional examples, the check meter 168 operates to continuously receive measured electrical power characteristics from each group meter and process that data along with measured electrical power characteristics measured by the check meter 168 to determine and apportion transmission link system losses between the check meter 168 and the group electrical power meters such as the first group electrical power meter M1 110, the second group electrical power meter M2 120, and the third group electrical power meter M3 130. In some examples, the operations of these meters cause the data processed by the check meter 168 to be at least one second old. This is referred to as a first minimum age time of the data and the data received from the group electrical power meters by the check meter 168 being at least one second old when it is processed by the check meter 168 is an example of the measured electrical power characteristics having a first minimum age time being at least one second.

In some examples of these conventional systems, the group electrical power meters are configured to request and receive the transmission link system losses and apportionment data that were calculated by the check meter 168. In some examples, the transmission link system losses and apportionment data that is received and processed by the group electrical power group electrical power meters is at least one second old when the group electrical power meters process that data. This is referred to as a second minimum age time of the transmission link system losses and the apportionment data and that the data received and processed by the group electrical power meters from the check meter 168 being at least one second old when it is processed by the group electrical power meters is an example of a second minimum age time being at least one second.

In some examples, the presently described systems and methods provide an improvement over the above described conventional systems that use processors within the check meter 168 and group electrical power meters perform transmission link system losses and apportionment data calculations. In examples, the above described controllers operate to receive the respective indication of measured electrical power characteristics for each respective electrical power generating resource, determine the respective loss value for each respective transmission link system, determine the apportionment of losses among transmission link systems, determine power adjustments to be made based on the apportionment of losses, and command the one or more generating resources to provide power based on the power adjustments all within a specified time. In some such examples, that processing is completed within one of a sum of the first minimum age time and the second minimum age time, within the first minimum age time, or within the second minimum age time. The elements of a process to adjust generating resource electrical output that are performed within the specified time are described in further detail below.

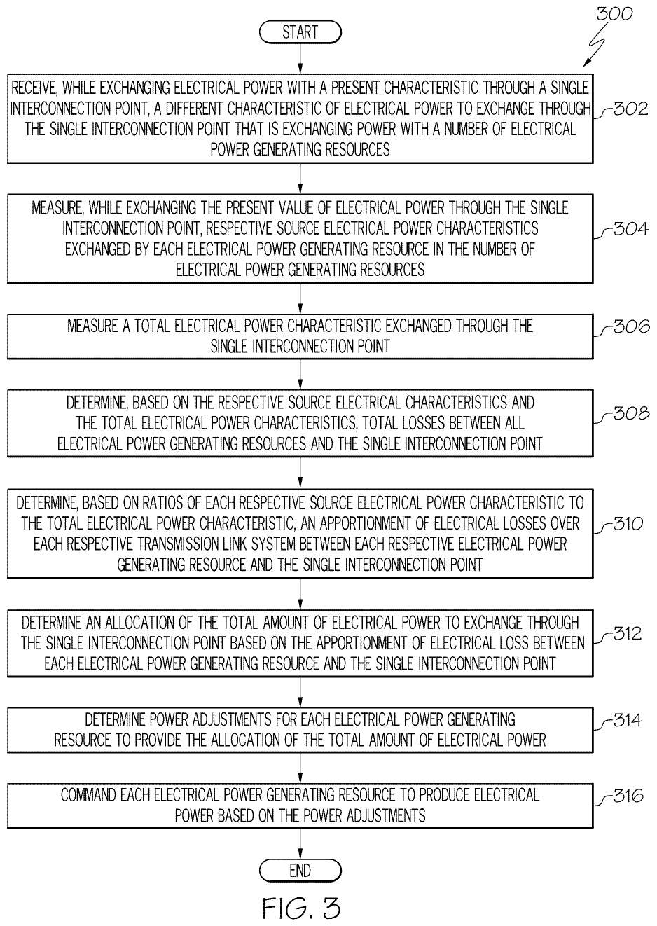

FIG. 3 illustrates a generating resource adjustment process 300, according to an example. The generating resource adjustment process 300 is an example of a process that is performed by the above described site controller 150, one or more of the local controllers, or a combination of these, as part of setting power output or demand for one or more generating resources of an electrical power generation system. In some examples, such a generating resource adjustment is performed based on various reasons, such as due to changes in the power output or demand of a generating resource, a change in control data for the electrical power site 160 that specifies a change in one or more characteristics of the electrical power to be delivered to the power interconnect 102, other factors, or any combination of these.

In an example, the generating resource adjustment process 300 includes receiving, at 302, while exchanging electrical power with a present characteristic through a single interconnection point, a different characteristic of electrical power to be exchanged through the single interconnection point that is exchanging power with a number of electrical power generating resources. An example of receiving a different characteristic includes, but is not limited to, receiving new control data from the external control 142 via the external control data link 144 that specifies the new characteristic. Receiving this data is an example of receiving control data defining characteristics of electrical power to be exchanged through the power interconnect point, wherein the control data defines characteristics of electrical power to be exchanged through the power interconnect point that differ from the indication of measured electrical power characteristics of power flowing through the power interconnect point.

The generating resource adjustment process 300 measures, at 304, while exchanging the present amount of electrical power through the single interconnection point, respective source electrical power characteristics exchanged with each electrical power generating resource in the number of electrical power generating resources. In an example, such measurements are performed by the group electrical meters, such as group electrical meter M1 110, group electrical meter M2 120, and group electrical meter M3 130. In an example, a group electrical meter for a particular electrical power generating resource is configured to measure a total amount of electrical power being one or both of produced by or consumed by that particular electrical power generating resource.

In an example, one or more of controller 1 152, controller 2 154, controller 3 156, the site controller 150, or any combination of these or other processors, operate to receive data measurements via a communications link where that data indicates values of the measured respective source electrical power characteristics exchanged with each electrical power generating resource. In the context of the present discussion, performing these measurements while exchanging the present amount of electrical power is able to refer to performing these measurements along with measuring the present amount of electrical power all within a specified time duration. An example of receiving such measurements is an example of receiving respective indications of measured electrical power characteristics for each of an electrical power generating resource in a plurality of electrical power generating resources, where each electrical power generating resource in the plurality of electrical power generating resources exchanges electrical power through the power interconnect point. Examples of such measured electrical power characteristics include, but are not limited to, real power, reactive power, voltage, current, other amounts, or combinations of these.

In some examples, subsequent to the measuring, at 304, respective source electrical power characteristics exchanged with each electrical power generating resource, a subsequent indication of measured electrical power characteristics for a particular electrical power generating resource within the plurality of electrical power generating resource is able to be received. In some examples, a determination is made that the subsequent indication differs from its previous indication of measured electrical power characteristic for the particular electrical power generating resource. Based on the determination of that difference, determining power adjustments, as is described below, is performed based on determining that the subsequent indication differs from the respective indication of measured electrical power characteristic for the particular electrical power generating resource indicates a different characteristic.

A total electrical power characteristic exchanged through the single interconnection point is measured, at 306. In an example, such a measurement is made by the check meter 168 and the site controller 150, one or more of the local controllers, or a combination of these receiving data indicating values of these measurements. Receiving such data is an example of receiving an indication of measured electrical power characteristics of power flowing through a power interconnect point.

In some examples, measuring, at 304, while exchanging the present amount of electrical power through the single interconnection point, respective source electrical power exchanged with each electrical power generating resource in the number of electrical power generating resources, and measuring, at 306, a total electrical power characteristic that is conveyed through the single interconnection point are all performed within a specified time duration. In various examples, this specified time duration is chosen based on a time duration over which the generating resources are able to change the characteristics of their electrical output, demand, or both. Such a time duration is able to be determined by any suitable technique such as analysis of response times of the generating resources, analysis of dynamic responses of various components such as the group electric meters, other considerations, or combinations of these. Performing these measurements and receipt of these measurements by the site controller 150 is an example of receiving the indication of measured electrical power characteristics of power flowing through a power interconnect point and receiving the respective indications of measured electrical power characteristics for each of the electrical power generating resource, all occurring within a specified time duration.

In some examples, the generating resource adjustment process 300 operates to cause processors to receive all indications of the electrical power characteristics measured by the above described measurements within certain timeframes. In an example, a controller receives indications of these measurements such that they all reflect electrical characteristics that were present within less than four hundred milliseconds (400 mS) prior to receipt by the controller. In a further example, a controller receives indications of these measurements such that they all reflect electrical characteristics that were present within less than one hundred milliseconds (100 mS) prior to receipt by the controller.

A total amount of loss between the electrical power generating resources and the single interconnection point is determined, at 308. In an example, the total amount of loss is determined based on the respective source electrical characteristics as measured, at 304, and the total electrical power characteristics, as measured above, at 306. In an example, this total amount of loss is determined based on a difference between a value of the total electrical power characteristic, such as a total level of power exchanged by the electrical power site 160 with the power interconnect 102, as measured by the check meter 168, and a value determined based on the respective source electrical characteristics, such as a sum of the electrical power generated or consumed by all of the generating resources of the electrical site. Determining this total amount of loss is an example of determining, based on the indication of electrical power characteristics of electrical power flowing through the power interconnect point and the respective indications of measured electrical power characteristics for each respective electrical power generating resource, a respective loss value for each respective transmission link system connecting each respective electrical power generating resource in the plurality of electrical power generating resources to the check meter providing power to the power interconnect point.

An apportionment of electrical losses over each respective transmission link between each respective electrical power generating resource and the single interconnection point is determined, at 310, based on ratios of each respective source electrical power characteristic to the total electrical power characteristic. Examples of determining such apportionments are described above. Such determining is an example of determining, based on the indication of measured electrical power characteristics of power flowing through a power interconnect point and the respective indications of measured electrical power characteristics for each of the electrical power generating resource, an apportionment of losses among transmission link systems connecting the plurality of generating resources to the power interconnect point.

An allocation of the total amount of electrical power to be exchanged through the single interconnection point is determined, at 312, based on the apportionment of electrical loss between or among each power generating resource and the single interconnection point. Such an allocation is made in an example based on the specified characteristics of the electrical power to be delivered through the interconnect meter to the power interconnect point and adjustments to the electrical power output of each generating resource to accommodate the losses apportioned to the transmission link system for that generating resource. Determining such an allocation is an example of determining, based on control data defining characteristics of electrical power to be exchanged through the power interconnect point, power adjustments to be made to one or more power generating resources based on the determined losses. In some examples, such determining electrical power allocations is based on receiving control data, at 302, which is an example of determining power adjustments based on receiving the control data. In some examples, the generating resource adjustment process 300 determines the total losses, at 308, determines the apportionment, at 310, and determines the allocation, at 312, all within a specified time limit. These determinations in an example are performed within twenty milliseconds (20 mS) of receipt of these indications.

Power adjustments for each electrical power generating resource are determined, at 314, to produce the allocation of the total amount of electrical power. Such determining is an example of determining, based on control data defining characteristics of electrical power to be exchanged through the power interconnect point, power adjustments to be made to one or more of the electrical power generating resources based on the apportionment of losses.

Each electrical power generating resource is commanded, at 316, to produce an amount of electrical power based on the above determined adjustments. Such a command in an example is communicated from the site controller 150 to a respective controller, such as the local controllers described above, in each generating resource. The generating resource adjustment process 300 then ends.

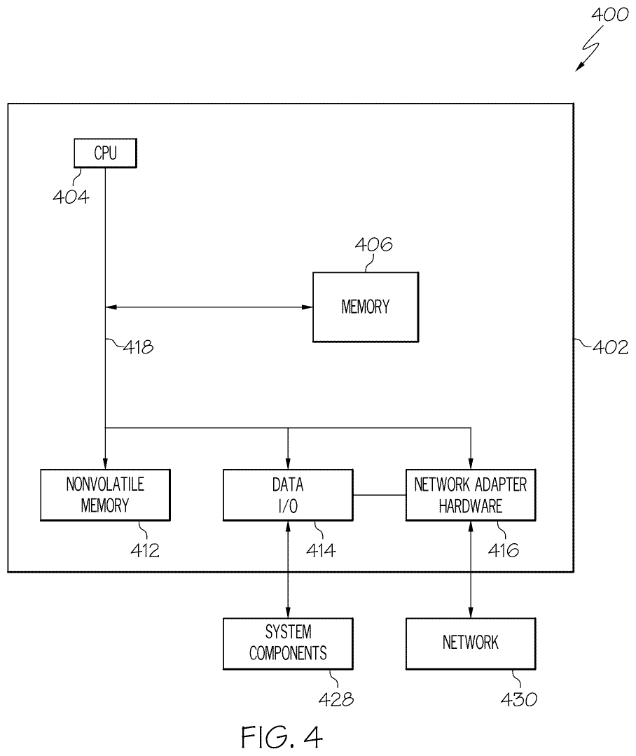

FIG. 4 illustrates a block diagram illustrating a controller 400 according to an example. The controller 400 is an example of a processing subsystem that is able to perform any of the above described processing operations, control operations, other operations, or combinations of these.

The controller 400 in this example includes a CPU 404 that is communicatively connected to a main memory 406 (e.g., volatile memory), a non-volatile memory 412 to support processing operations. The CPU is further communicatively coupled to a network adapter hardware 416 to support input and output communications with external computing systems such as through the illustrated network 430.

The controller 400 further includes a data input/output (I/O) processor 414 that is able to be adapted to communicate with any type of equipment, such as the illustrated system components 428. The data input/output (I/O) processor in various examples is able to be configured to support any type of data communications connections including present day analog and/or digital techniques or via a future communications mechanism. A system bus 418 interconnects these system components.

In other examples, azimuth offset may be based not only on wind direction, but also air temperature, air humidity and other atmospheric affects.

### Information Processing System

The present subject matter can be realized in hardware, software, or a combination of hardware and software. A system can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein.

The present subject matter can also be embedded in a computer program product, which comprises all the features enabling the implementation of the methods described herein, and which-when loaded in a computer system—is able to carry out these methods. Computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. In general, the computer readable medium embodies a computer program product as a computer readable storage medium that embodies computer readable program code with instructions to control a machine to perform the above described methods and realize the above described systems.

### Non-Limiting Examples

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

1. A method for controlling electrical power output of a generating resource site that includes a plurality of electrical power generating resources, the method comprising:
receiving, at a controller, an indication of electrical power characteristics of electrical power flowing through a power interconnect point as measured by a check meter;
receiving, at the controller, respective indications of measured electrical power characteristics for each respective electrical power generating resource, where each electrical power generating resource exchanges electrical power through the power interconnect point,
determining, by the controller, based on the indication of electrical power characteristics of electrical power flowing through the power interconnect point and the respective indications of measured electrical power characteristics for each respective electrical power generating resource:
a respective loss value for each respective transmission link system connecting each respective electrical power generating resource in the plurality of electrical power generating resources to the check meter, and
an apportionment of losses among transmission link systems connecting the plurality of electrical power generating resources to the power interconnect point;
determining, based on control data defining characteristics of electrical power to be exchanged through the power interconnect point, power adjustments to be made to one or more of the electrical power generating resources based on the apportionment of losses; and
commanding the one or more of the electrical power generating resources to produce electrical power based on the power adjustments.

2. The method of claim 1, wherein the respective indications of measured electrical power characteristics reflect electrical characteristics for the respective electrical power generating resource present within less than four hundred milliseconds (400 mS) prior to receipt by the controller.

3. The method of claim 1, further comprising receiving the control data defining characteristics of electrical power to be exchanged through the power interconnect point, wherein the control data defines characteristics of electrical power to be exchanged through the power interconnect point that differ from the indication of measured electrical power characteristics of power flowing through the power interconnect point, and
wherein the determining the power adjustments is based on receiving the control data.

4. The method of claim 1, further comprising:
receiving a subsequent indication of measured electrical power characteristics for a particular electrical power generating resource within the plurality of electrical power generating resources; and
determining that the subsequent indication differs from the respective indication of measured electrical power characteristic for the particular electrical power generating resource, and
wherein the determining the power adjustments is performed based on determining that the subsequent indication differs from the respective indication of measured electrical power characteristic for the particular electrical power generating resource indicating a different characteristic.

5. The method of claim 1, wherein determining the apportionment of losses is based on a loss ratio comprising a ratio of a square of electrical current flowing through a particular electrical power generating resource to a sum of all respective squares of electrical current flowing through each electrical power generating resource in the plurality of electrical power generating resources.

6. The method of claim 1, wherein determining the apportionment of losses is based on a combination of no-load losses and load losses, wherein:
the no-load losses are allocated to each respective electrical power generating resource based on a ratio of a respective electrical power generating resource rated power capacity to a total rated power capacity of all the electrical power generating resources within the plurality of electrical power generating resources, and
the load losses are allocated to each respective electrical power generating resource based on a ratio of a product of voltage and amperage of each respective electrical power generating resource to a total of products of voltage and amperage of all electrical power generating resources.

7. The method of claim 1, wherein the respective indications of measured electrical power characteristics reflect electrical characteristics for each respective electrical power generating resource present within less than one hundred milliseconds (100 mS) prior to receipt at the controller.

8. The method of claim 1, wherein:
the indication comprising values of the electrical power characteristics of electrical power flowing through the power interconnect point were measured within less than four hundred milliseconds (400 mS) of receipt at the controller; and
determining the respective loss value and the apportionment is performed by the controller within less than twenty milliseconds (20 mS) after receipt of the respective indications of electrical power characteristics for each respective electrical power generating resource.

9. The method of claim 1, wherein the indication comprising values of the electrical power characteristics of electrical power flowing through the power interconnect point were measured within less than one hundred milliseconds (100 mS) of receipt at the controller.

10. The method of claim 1, wherein receiving the respective indications of measured electrical power characteristics comprises receiving the respective indications of electrical power characteristics from a respective group power meter, where each respective group power meter measures electrical power characteristic for a respective associated electrical power generating resource in the plurality of electrical power generating resources.

11. The method of claim 10, wherein the check meter is configured to receive the respective indications of measured electrical power characteristics for each respective electrical power generating resource and processing those with a first minimum age time;
wherein each respective group power meter is configured to request and receive information from the check meter with a second minimum age time; and
wherein the receiving the respective indication of measured electrical power characteristics for each respective electrical power generating resource, determining the respective loss value for each respective transmission link system, determining the apportionment of losses among transmission link systems, determining power adjustments to be made based on the apportionment of losses, and commanding the one or more generating resources to provide power based on the power adjustments are performed within a sum of the first minimum age time and the second minimum age time.

12. A system for adjusting electrical power output of a generating resource site that includes a plurality of electrical power generating resources, comprising:
a processor;
a memory communicatively coupled to the processor; and
a power output allocation processor, communicatively coupled to the processor and the memory, the power output allocation processor, when operating, configured to:
receive an indication of electrical power characteristics of electrical power flowing through a power interconnect point as measured by a check meter;
receive respective indications of measured electrical power characteristics for each respective electrical power generating resource, where each electrical power generating resource exchanges electrical power through the power interconnect point,
determine based on the indication of electrical power characteristics of electrical power flowing through the power interconnect point and the respective indications of measured electrical power characteristics for each respective electrical power generating resource:
a respective loss value for each respective transmission link system connecting each respective electrical power generating resource in the plurality of electrical power generating resources to the check meter, and
an apportionment of losses among transmission link systems connecting the plurality of electrical power generating resources to the power interconnect point;
determine, based on control data defining characteristics of electrical power to be exchanged through the power interconnect point, power adjustments to be made to one or more of the electrical power generating resources based on the apportionment of losses; and
command the one or more of the electrical power generating resources to produce electrical power based on the power adjustments.

13. The system of claim 12, wherein the respective indications of measured electrical power characteristics reflect electrical characteristics for the respective electrical power generating resource present within less than four hundred milliseconds (400 mS) prior to receipt by the power output allocation processor.

14. The system of claim 12, wherein the power output allocation processor, when operating, is further configured to:
receive the control data defining characteristics of electrical power to be exchanged through the power interconnect point, wherein the control data defines characteristics of electrical power to be exchanged through the power interconnect point that differ from the indication of measured electrical power characteristics of power flowing through the power interconnect point; and
determine the power adjustments based on receiving the control data.

15. The system of claim 12, wherein the power output allocation processor, when operating, is further configured to:
receive a subsequent indication of measured electrical power characteristics for a particular electrical power generating resource within the plurality of electrical power generating resources; and
determine that the subsequent indication differs from the respective indication of measured electrical power characteristic for the particular electrical power generating resource, and
wherein the power output allocation processor, when operating, determines the power adjustments based on determining that the subsequent indication differs from the respective indication of measured electrical power characteristic for the particular electrical power generating resource indicating a different characteristic.

16. The system of claim 12, wherein the power output allocation processor, when operating, is further configured to receive the respective indications of electrical power characteristics from respective group power meters, where each respective group power meter measures electrical power characteristic for a respective associated electrical power generating resource in the plurality of electrical power generating resources, and
wherein the check meter is configured to receive the respective indications of measured electrical power characteristics for each respective electrical power generating resource and processing those with a first minimum age time;
wherein each respective group power meter is configured to request and receive information from the check meter with a second minimum age time; and
wherein the power output allocation processor, when operating, is further configured to receive the respective indication of measured electrical power characteristics for each respective electrical power generating resource, determine the respective loss value for each respective transmission link system, determine the apportionment of losses among transmission link systems, determine power adjustments to be made based on the apportionment of losses, and command the one or more generating resources to provide power based on the power adjustments within a time less than a sum of the first minimum age time and the second minimum age time.

17. A computer program product for adjusting electrical power output of a generating resource site that includes a plurality of electrical power generating resources, the computer program product comprising:
a non-transitory computer readable storage medium having computer readable program code embodied therewith, the computer readable program code comprising instructions for:
receiving, at the controller, respective indications of measured electrical power characteristics for each respective electrical power generating resource, where each electrical power generating resource exchanges electrical power through the power interconnect point,
determining, by the controller, based on the indication of electrical power characteristics of electrical power flowing through the power interconnect point and the respective indications of measured electrical power characteristics for each respective electrical power generating resource:
a respective loss value for each respective transmission link system connecting each respective electrical power generating resource in the plurality of electrical power generating resources to the check meter, and
an apportionment of losses among transmission link systems connecting the plurality of electrical power generating resources to the power interconnect point;
determining, based on control data defining characteristics of electrical power to be exchanged through the power interconnect point, power adjustments to be made to one or more of the electrical power generating resources based on the apportionment of losses; and
commanding the one or more of the electrical power generating resources to produce electrical power based on the power adjustments.

18. The computer program product of claim 17, wherein the computer readable program code further comprises instructions for:
receiving a subsequent indication of measured electrical power characteristics for a particular electrical power generating resource within the plurality of electrical power generating resources; and
determining that the subsequent indication differs from the respective indication of measured electrical power characteristic for the particular electrical power generating resource, and
wherein the instructions for determining the power adjustments are executed based on determining that the subsequent indication differs from the respective indication of measured electrical power characteristic for the particular electrical power generating resource indicating a different characteristic.

19. The computer program product of claim 17, wherein the instructions for determining the apportionment of losses comprises instructions for determining the apportionment of losses based on a loss ratio comprising a ratio of a square of electrical current flowing through a particular electrical power generating resource to a sum of all respective squares of electrical current flowing through each electrical power generating resource in the plurality of electrical power generating resources.

20. The computer program product of claim 17, wherein the instructions for determining the apportionment of losses comprises instructions for determining the apportionment of losses based on a combination of no-load losses and load losses, wherein:
the no-load losses are allocated to each respective electrical power generating resource based on a ratio of a respective electrical power generating resource rated power capacity to a total rated power capacity of all electrical power generating resources within the plurality of electrical power generating resources, and
the load losses are allocated to each respective electrical power generating resource based on a ratio of a product of voltage and amperage of each respective electrical power generating resource to a total of products of voltage and amperage of all electrical power generating resources.
